(19) United States
(12) Patent Application Publication
(10) Pub. No.: US 2006/0031398 A1
(43) Pub. Date: Feb. 9, 2006

(54) Apparatus, method, and computer product for web-based data management

(75) Inventor: Yukio Hirao, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/168,766

(22) Filed: Jun. 29, 2005

Related U.S. Application Data
(63) Continuation of application No. PCT/JP03/07888, filed on Jun. 20, 2003.

(51) Int. Cl. G06F 15/16

(52) U.S. Cl. 709/217

(57) ABSTRACT

An apparatus for managing data on a web page, through a web browser at a client device via a network, includes a receiving unit that receives a request from the client device to start a client application installed in the client device, where the client application is specified by a user on the web page, a reading unit that reads, from a memory, a startup procedure for starting the client application, when the request is received, and a transmitting unit that transmits the startup procedure to the client device.

### BACKGROUND OF THE INVENTION

1. Field of the Invention

The present invention relates to a technology for executing, from the web browser, a client application installed in the client device.

2. Description of the Related Art

Data and services are provided by various servers on an intranet or the Internet. Among these, data and services that are frequently used by a user are organized, integrated, and offered on a portal screen. By using the customized portal screen, the user can efficiently access the data and the services from a client device such as a personal computer.

Moreover, when a user specifies a document for viewing on a web page, an application program for viewing the document is executed in the web browser. Thus, documents prepared by different application programs can be easily displayed on the web page.

This technology is disclosed in, for example, “An overview of ActiveX technology”, on Microsoft Support Online, searched on May 6, 2003 (http://support.microsoft.com/default.aspx?scid=kb%3bja%3b8 79760).

However, in the conventional technology, client applications installed in the client device cannot be started from the web page. Specifically, a user is required to start the client application, such as an e-mail program, from outside the web browser, by double-clicking an icon on a desktop screen, or selecting a program from a start menu, and so forth.

Because the client applications cannot be started from the portal screen, the purpose of the portal screen is limited to accessing web related services.

### SUMMARY OF THE INVENTION

It is an object of the present invention to at least solve the problems in the conventional technology.

According to an aspect of the present invention, an apparatus for managing data on a web page, through a web browser at a client device via a network, includes a receiving unit that receives a request from the client device to start a client application installed in the client device, where the client application is specified by a user on the web page; a reading unit that reads, from a memory, a startup procedure for starting the client application, when the request is received; and a transmitting unit that transmits the startup procedure to the client device.

According to another aspect of the present invention, a method of for managing data on a web page, through a web browser at a client device via a network, includes receiving a request from the client device to start a client application installed in the client device, where the client application is specified by a user on the web page; reading, from a memory, a startup procedure for starting the client application, when the request is received; and transmitting the startup procedure to the client device.

According to still another aspect of the present invention, a computer-readable recording medium stores therein a computer program including instructions, which when executed, cause a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining starting of client applications from a portal screen according to an embodiment of the present invention;

FIG. 2 is a functional block diagram of a portal screen management system according to the embodiment;

FIG. 3 is an example of authentication data stored in a portal-screen data storing unit shown in FIG. 2;

FIG. 4 is an example of a data structure of startup scripts, for starting client applications, stored in the portal-screen data storing unit;

FIG. 5 is an example of a data structure of information related to plug-in programs, stored in the portal-screen data storing unit;

FIG. 6 is a flowchart of a process procedure performed by a portal screen management program shown in FIG. 2;

FIG. 7 is a flowchart of a process procedure for starting a client application, performed by a portal HTML shown in FIG. 2;

FIG. 8 is a flowchart of a process procedure for starting the client application, performed by a script executing unit shown in FIG. 2;

FIG. 9 is a sequence of starting a client application from the portal screen according to the embodiment;

FIG. 10 is an example of an input form to input a user ID and a password required to log on to an e-mail client;

FIG. 11 is an example of a screen displayed when a log-on sequence is performed;

FIG. 12 is a part of an example of the portal HTML;

FIG. 13 is a part of an example of the script for starting the client application;

FIG. 14 is a diagram of a computer system that executes a web browser and the client application, or the portal screen management program; and

FIG. 15 is a functional block diagram of a main unit shown in FIG. 14.

### DETAILED DESCRIPTION OF THE PREFERRED EMBODIMENTS

Exemplary embodiments of the present invention will be described below with reference to accompanying drawings. The present invention is not limited to these embodiments.

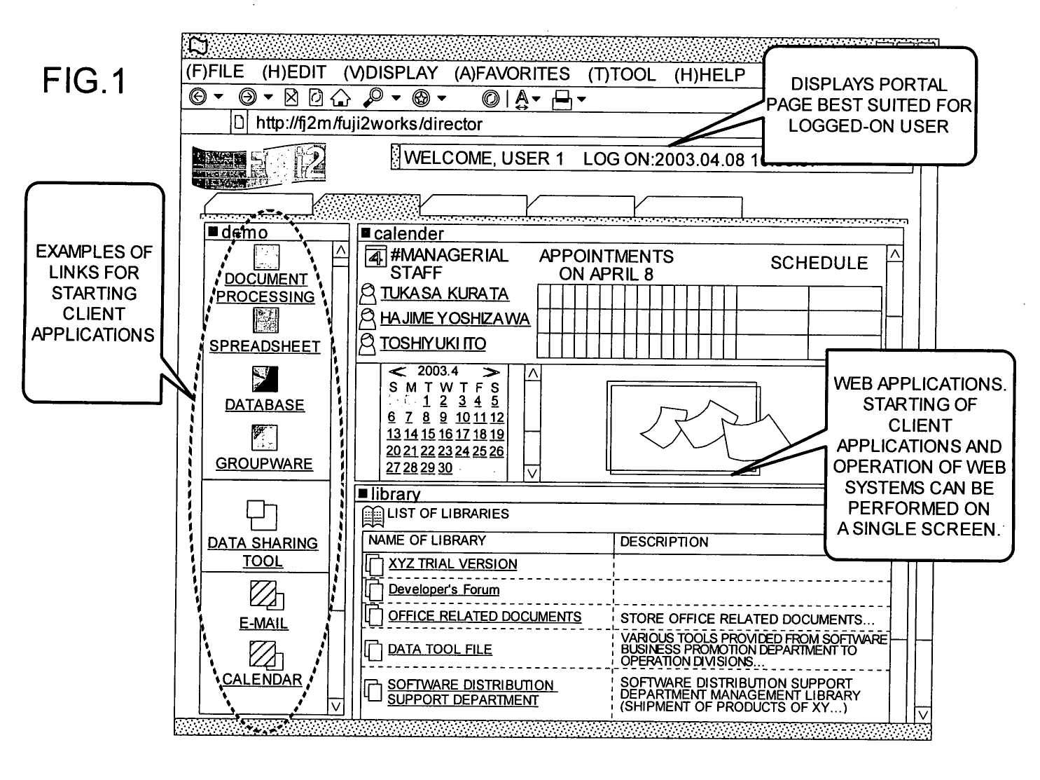

FIG. 1 is a diagram for explaining starting of client applications from a portal screen.

The diagram is an example of the portal screen according to the embodiment. Links displayed on the left side are used to start the client applications. Examples of the client applications include a document processing program and a spreadsheet program that do not require authentication data, and an e-mail program that requires authentication data. According to the embodiment, all of these client applications can be started from the portal screen.

However, in case of the conventional technology, the client applications cannot be started from the conventional portal screen. A user is required to start the client applications from outside the conventional portal screen, by double-clicking an icon on a desktop screen, or selecting a program from a start menu, and so forth.

However, according to the present embodiment, the client applications can be started directly from the portal screen, and therefore, both web related services and client application services are offered in a single, seamless environment.

Moreover, when the client application requiring authentication data, such as the e-mail program, is started from the portal screen, the authentication data is automatically passed from a server to the client application. Thus, the authentication data is automatically input instead of the user inputting the data. Furthermore, initial operations required for using the client application are automatically performed, instead of the user performing the initial operations.

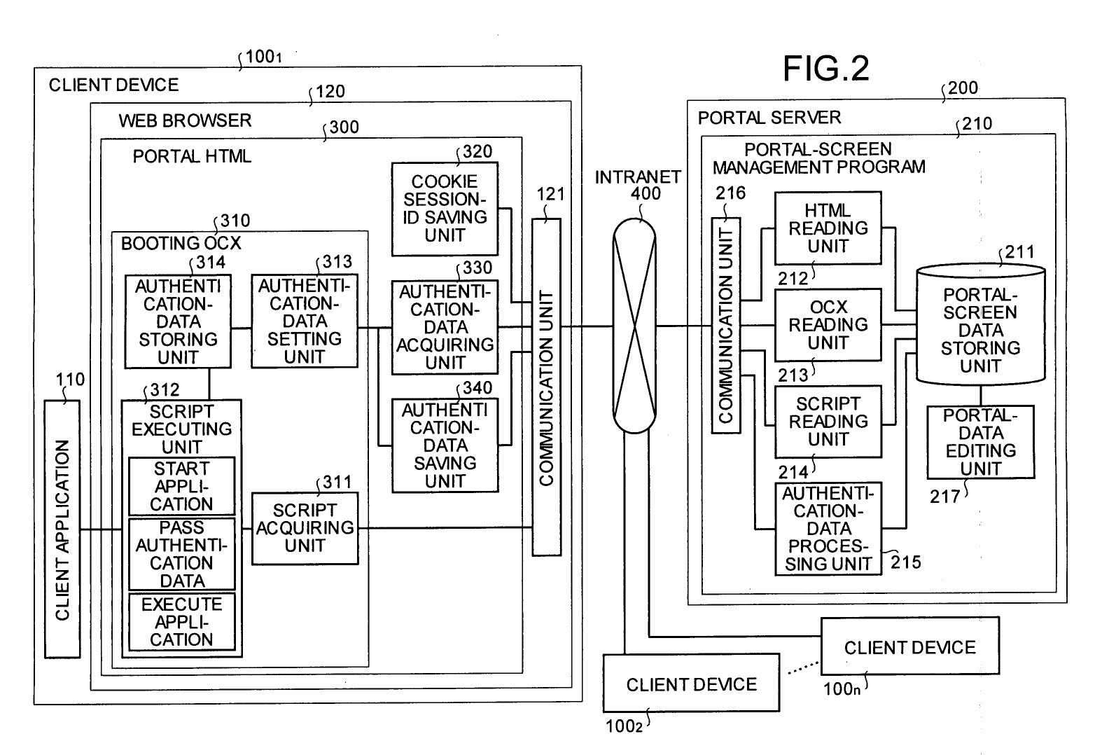

FIG. 2 is a functional block diagram of a portal screen management system according to the embodiment. The portal screen management system includes a portal server 200 that manages data related to the portal screen, and an n number of client devices 100₁ to 100ₙ connected to the portal server 200 through an intranet 400.

The client devices 100₁ to 100ₙ may be connected to the portal server 200 through the Internet or any other network, instead of or in addition to the intranet 400. All of the client devices 100₁ to 100ₙ have the same configuration, so only the client device 100₁ is considered as an example.

The client device 100₁ executes a client application 110, and a web browser 120. The client application 110 is started from the web browser 120. The client application 110 can be, for example, a document processing program, a spreadsheet program, or an e-mail program.

The web browser 120 is a program for using data and services provided by a server in the intranet 400 or the Internet. The web browser 120 uses a communication unit 121 to read a file written in Hyper Text Markup Language (HTML) from the portal server 200, and displays the file at the client device 100₁. Moreover, the web browser 120 downloads from the portal server 200 plug-in programs required to execute the HTML, and executes the plug-in programs.

The web browser 120 reads a portal HTML 300 that is an HTML description, from the portal server 200. The web browser 120 interprets and executes the portal HTML 300 to display the portal screen at the client device 100₁. The portal HTML 300 includes HTML descriptions to download a booting OLE Custom Control (OCX) 310 from the portal server 200, a cookie session-ID saving unit 320, an authentication-data acquiring unit 330, and an authentication-data saving unit 340.

When the portal HTML 300 is read from the portal server 200 for the first time, the booting OCX 310, a plug-in program, is automatically downloaded by the web browser 120, and is then incorporated in the web browser 120. When a user selects the client application 110 from the portal screen, the booting OCX 310 is executed so that the client application 110 starts.

The booting OCX 310 includes a script acquiring unit 311, a script executing unit 312, an authentication-data setting unit 313, and an authentication-data storing unit 314.

The script acquiring unit 311 requests a script for starting the client application 110 from the portal server 200, and receives the script from the portal server 200.

The script executing unit 312 executes the script acquired by the script acquiring unit 311 to start the client application 110. The script executed by the script executing unit 312 also performs operations other than starting the client application 110. When the client application 110 requires authentication data, the script passes the authentication data to the client application 110. Moreover, when a predetermined operation is required after starting the client application 110, the script automatically performs the operation.

A user can start the client application 110 directly from the portal screen because the script executing unit 312 executes the script for starting the client application 110. Instead of directly incorporating the script for starting the client application 110 into the portal HTML 300, the portal HTML 300 executes the booting OCX 310, so that the booting OCX 310 reads the script from the portal server 200 and executes the script. Thus, the contents of the script for starting the client application 110 can be kept confidential.

The authentication-data setting unit 313 sets authentication data in the authentication-data storing unit 314, if the client application 110 requires authentication data. The authentication data includes a user ID and a password.

The script executed by the script executing unit 312 reads the authentication data stored in the authentication-data storing unit 314, and passes the data to the client application 110.

The cookie session-ID saving unit 320 saves a session ID that is used to log on to the portal screen. The session ID is used for authentication when the booting OCX 310 reads the script from the portal server 200.

Thus, when a request to read the script is made by the client device 100₁ that is logged on to the portal screen, the portal server 200 confirms the session ID and allows the client device 100₁ to read the script. However, if the session ID cannot be confirmed, the portal server 200 does not allow a request to read the script from another unauthenticated client device.

Accordingly, the script is prevented from being illegally downloaded.

When the client application 110 requires authentication data, the authentication-data acquiring unit 330 acquires authentication data, and stores the data in the authentication-data storing unit 314. The authentication-data acquiring unit 330 requests a user to input a user ID and a password, when the client application 110 is started from the portal screen for the first time. From the second time on, the authentication-data acquiring unit 330 acquires the user ID and the password from the portal server 200.

If the client application 110 is started for the first time, the authentication-data saving unit 340 saves the user ID and the password input by the user. The authentication-data saving unit 340 then saves the user ID and the password in the portal server 200, so that the user is not required to input the authentication data every time the client application 110 starts.

The portal server 200 executes a portal-screen management program 210. The portal-screen management program 210 manages data related to the portal screen such as the HTML description, the plug-in program, and the script.

The portal-screen management program 210 includes a portal-screen data storing unit 211, an HTML reading unit 212, an OCX reading unit 213, a script reading unit 214, an authentication-data processing unit 215, a communication unit 216, and a portal-data editing unit 217.

The portal-screen data storing unit 211 stores data related to the portal screen, such as the HTML description for displaying the portal screen, authentication data required to use the client application 110, the script for starting the client application 110, and the plug-in program for starting the client application 110.

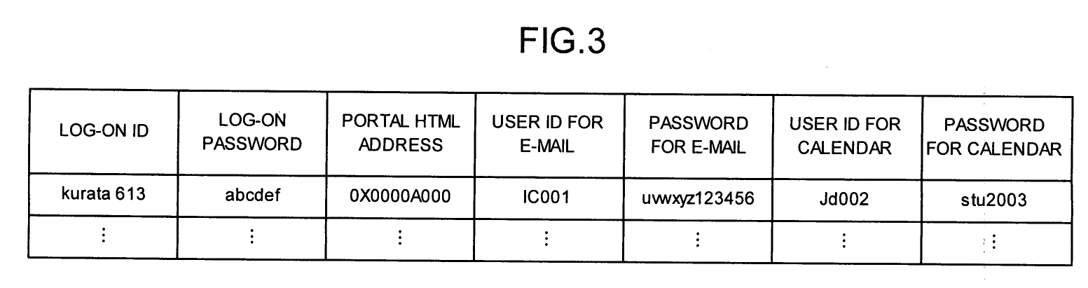

FIG. 3 is an example of authentication data stored in the portal-screen data storing unit 211. The portal-screen data storing unit 211 stores, for each user, a log-on ID and a log-on password required when logging on to the portal screen, a portal HTML address where the portal HTML 300 is stored, a user ID and a password for an e-mail client, and a user ID and a password for a calendar client.

For example, when a user's log-on ID is “kurata613”, the log-on password is “abcdef”, the portal HTML address is 0X0000A000, the user ID and the password for the e-mail client are “IC001” and “uvwxyz123456”, the user ID and the password for the calendar client are “Jd002” and “stu2003”. These IDs and passwords shown are data before being encrypted, however, they are encrypted when stored in the portal-screen data storing unit 211.

Thus, the portal-screen data storing unit 211 stores the authentication data necessary at the time of starting the client application 110 that requires authentication data. Thus, the user need not input the authentication data every time the client application 110 starts.

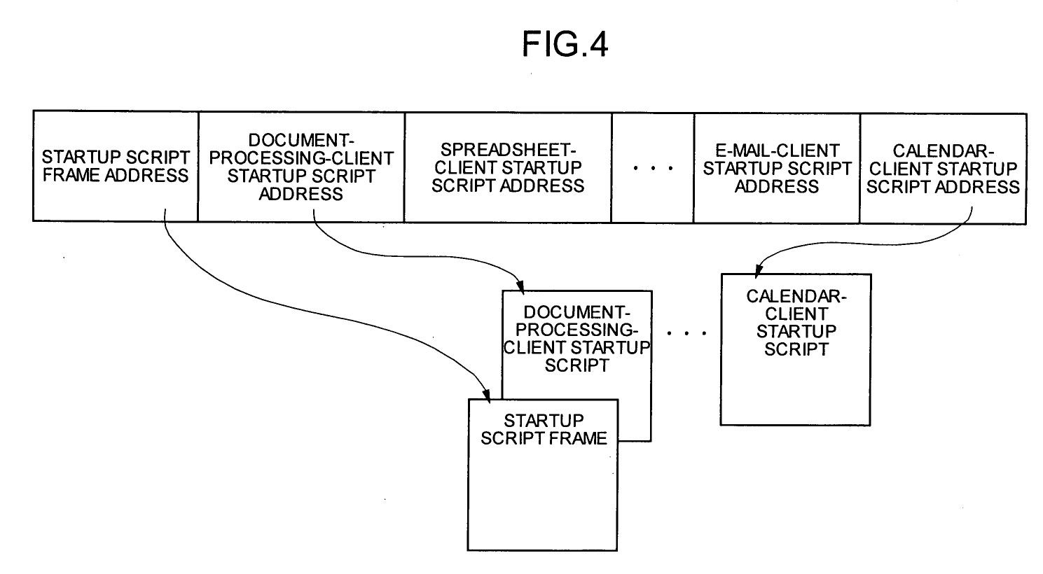

FIG. 4 is an example of a data structure of the startup scripts, for starting client applications, stored in the portal-screen data storing unit 211.

The portal-screen data storing unit 211 stores a startup script frame, a document-processing-client startup script, a spreadsheet-client startup script, an e-mail-client startup script, a calendar-client startup script, and addresses of these scripts.

The startup script frame defines a frame of a startup script, and is used when generating a script for starting the client application 110. Various scripts for starting different client applications 110 can be easily generated by using the startup script frame.

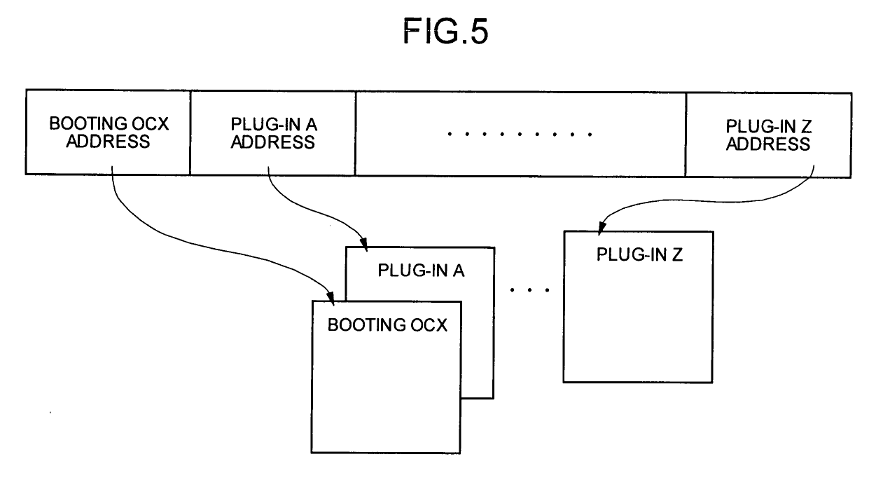

FIG. 5 is an example of a data structure of information related to the plug-in programs, stored in the portal-screen data storing unit 211. The portal-screen data storing unit 211 stores the booting OCX 310, plug-in programs such as plug-in A, plug-in Z, and addresses of the programs.

Returning to FIG. 2, upon receiving a user's request from the client device 100₁, the HTML reading unit 212 reads, from the portal-screen data storing unit 211, the portal HTML 300 describing a portal screen corresponding to the user.

Upon receiving a request from the client device 100₁, the OCX reading unit 213 reads, from the portal-screen data storing unit 211, plug-in programs such as the booting OCX 310.

Upon receiving a request from the client device 100₁, the script reading unit 214 reads, from the portal-screen data storing unit 211, a script for starting the client application 110. The script reading unit 214 confirms a session ID saved in the client device 100₁, and accepts the request only if the session ID is confirmed. The script reading unit 214 then reads the script from the portal-screen data storing unit 211.

Accordingly, the script is prevented from being illegally downloaded by unauthenticated users, and usage of the script is restricted to authenticated users.

The authentication-data processing unit 215 receives a user ID and a password that is input by the user when the client application 110 is started for the first time, and stores the data as authentication data corresponding to the user in the portal-screen data storing unit 211. Therefore, from the second time on, the authentication-data processing unit 215 can read the user ID and the password from the portal-screen data storing unit 211. The authentication-data processing unit 215 encrypts the user ID and the password when storing them in the portal-screen data storing unit 211. The user ID and the password are decrypted when the authentication-data processing unit 215 reads them from the portal-screen data storing unit 211. The authentication-data processing unit 215 passes the decrypted data to the authentication-data acquiring unit 330.

The authentication-data processing unit 215 saves, in the portal-screen data storing unit 211, user IDs and passwords corresponding to users as authentication data for the client application 110. Thus, the authentication-data processing unit 215 can automatically input a user ID and a password in the client application 110, instead of the user inputting the data.

The communication unit 216 receives a request to read data related to the portal screen from the client device 100₁. In response to the request, the communication unit 216 transmits from the portal-screen data storing unit 211 to the client device 100₁, data read by the HTML reading unit 212, the OCX reading unit 213, the script reading unit 214, and the authentication-data processing unit 215.

The portal-data editing unit 217 edits an HTML description of a portal screen stored in the portal-screen data storing unit 211 and a script for starting the client application 110. By using the portal-data editing unit 217, an administrator of a portal screen can easily create a portal screen to start various client applications 110.

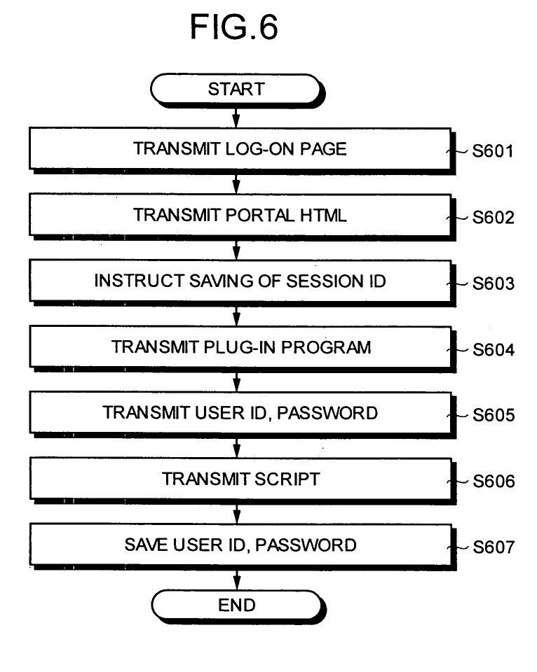

FIG. 6 is a flowchart of a process procedure performed by the portal-screen management program 210 shown in FIG. 2.

When a user accesses a URL managed by the portal-screen management program 210 from the client device 100₁, the HTML reading unit 212 reads data of a log-on page from the portal-screen data storing unit 211, and transmits the data to the client device 100₁ (step S601).

When the user inputs a log-on ID and a log-on password to log on to the portal screen, the portal server 200 authenticates the user. Then, the HTML reading unit 212 reads, from the portal-screen data storing unit 211, the portal HTML 300 corresponding to the user, and transmits the portal HTML 300 to the client device 100₁ (step S602).

The system control instructs the client device 100₁ to save the session ID (the log-on ID and the log-on password) (step S603). If the user has accessed the portal HTML 300 the first time, the OCX reading unit 213 transmits plug-in programs such as the booting OCX 310 to the client device 100₁ (step S604).

If the user has started the client application 110 a second time or thereafter, the script reading unit 214 reads a user ID and a password for the client application 110 specified by the client device 100₁ from the portal-screen data storing unit 211, decrypts the data, and transmits the data to the client device 100₁ (step S605).

Upon receiving a request for a script to start the client application 110 from the client device 100₁, the script reading unit 214 confirms the session ID. When the session ID is confirmed, the script reading unit 214 reads the script from the portal-screen data storing unit 211, and transmits the script to the client device 100₁ (step S606).

If the user starts the client application 110 the first time, the script reading unit 214 receives a user ID and a password from the client device 100₁, encrypts the data, and stores the data to the portal-screen data storing unit 211 (step S607). If the client application 110 does not start properly, a user ID and a password are not transmitted from the client device 100₁, and are not stored in the portal-screen data storing unit 211.

Accordingly, the portal-screen management program 210 transmits a script for starting the client application 110 in response to a request from the client device 100₁. Thus, the user can start the client application 110 directly from the web browser 120 at the client device 100₁.

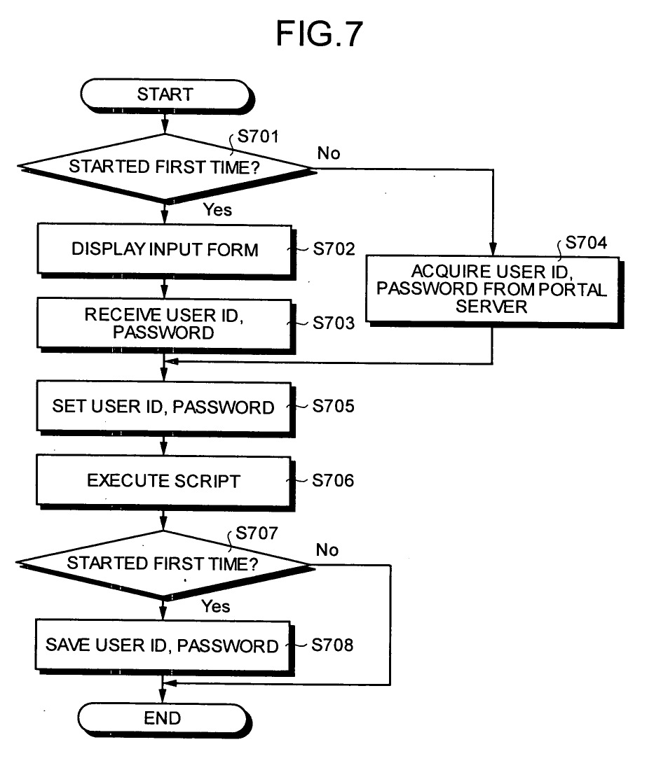

FIG. 7 is a flowchart of a process procedure for starting the client application 110, performed by the portal HTML 300 shown in FIG. 2.

The portal HTML 300 determines whether the client application 110 is started the first time (step S701). If the client application 110 is started the first time, the authentication-data acquiring unit 330 displays an input form for inputting a user ID and a password (step S702), and a user inputs the user ID and the password to the input form (step S703). On the other hand, if the client application 110 is started the second time or thereafter, the authentication-data acquiring unit 330 specifies a name of the client application 110, and acquires the user ID and the password from the portal server 200 (step S704).

The portal HTML 300 uses the booting OCX 310 to set the user ID and the password in the authentication-data storing unit 314 (step S705), and executes a script for starting the client application 110 (step S706).

If the client application 110 is started the first time (Yes at step S707), the authentication-data saving unit 340 transmits the user ID and the password to the portal server 200 (step S708). If the client application 110 does not start properly, the authentication-data saving unit 340 does not transmit the user ID or the password to the portal server 200.

Accordingly, the portal HTML 300 uses the booting OCX 310 to execute the script for starting the client application 110. Therefore, the client application 100 can be started directly from the web browser 120.

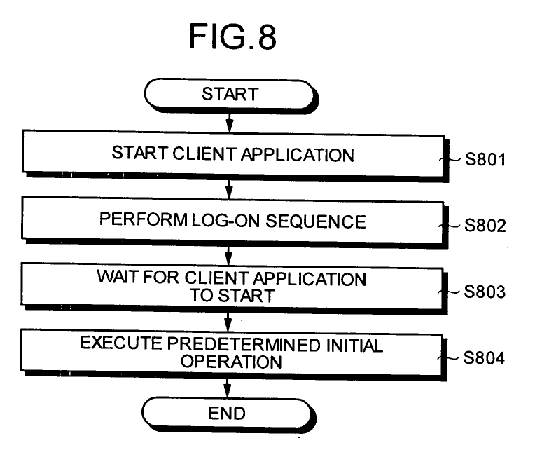

FIG. 8 is a flowchart of a process procedure for starting the client application 110, performed by the script executing unit 312 shown in FIG. 2.

The script executing unit 312 starts the client application 110 specified by a user from the web browser 120 (step S801), and performs a log-on sequence for the client application 110 that requires authentication data (step S802). “Performing the log-on sequence” includes passing a user ID and a password stored in the authentication-data storing unit 314 to the client application 110.

Then, the script executing unit 312 waits for the client application 110 to start (step S803). When the client application 110 starts, and predetermined initial operations need to be performed, the script executing unit 312 performs those operations automatically (step S804).

Thus, the script executing unit 312 starts the client application 110, performs the log-on sequence for the client application 110 when the client application 110 requires authentication data, and automatically performs predetermined initial operations if necessary. Thus, the client application 110 is started efficiently.

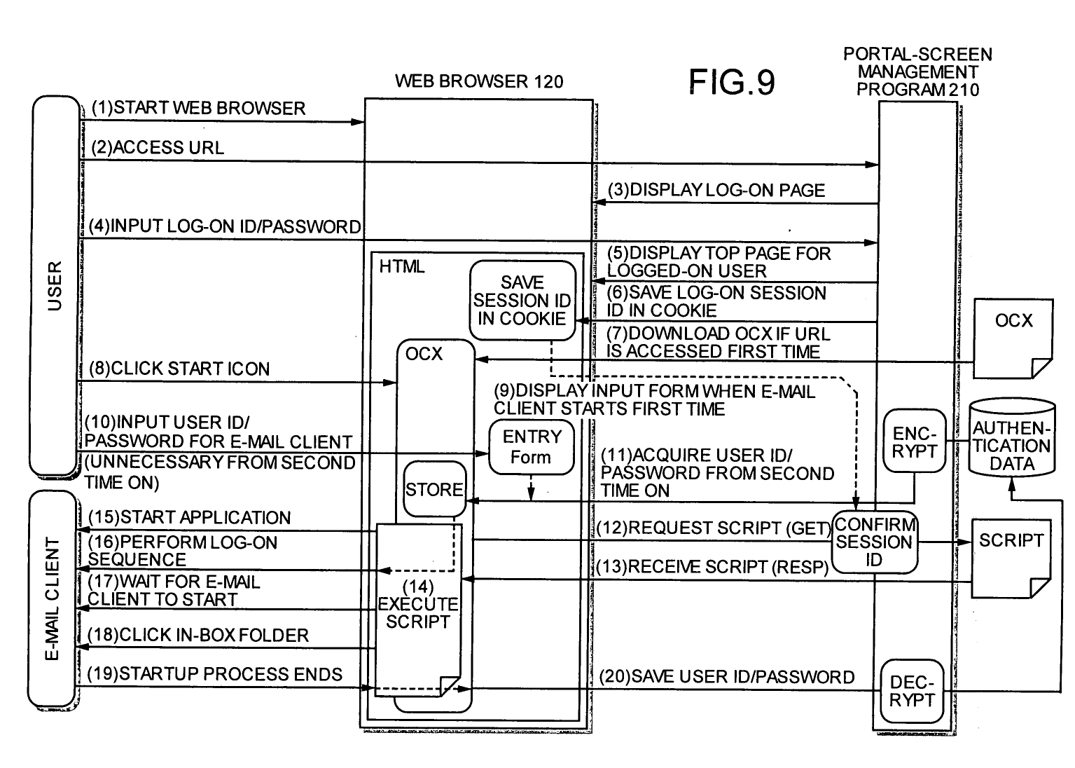

FIG. 9 is a sequence of starting the client application 110 from the portal screen according to the embodiment. Here, an e-mail client is explained as an example of the client application 110.

When a user starts the web browser 120 at the client device 100, (1), and the web browser 120 accesses a URL managed by the portal-screen management program 210 (2), the portal-screen management program 210 transmits data of a log-on page to the web browser 120, and the web browser 120 displays the log-on page (3).

The user inputs a log-on ID and a log-on password to log on to the portal screen (4). The portal-screen management program 210 authenticates the user, and transmits to the web browser 120, an HTML description of a portal screen corresponding to the user, and the web browser 120 interprets and executes the HTML description to display the portal screen (5). The web browser 120 saves a session ID of this log-on session (6).

If the user accesses the URL for the first time, the web browser 120 requests an OCX from the portal-screen management program 210, and downloads the OCX (7).

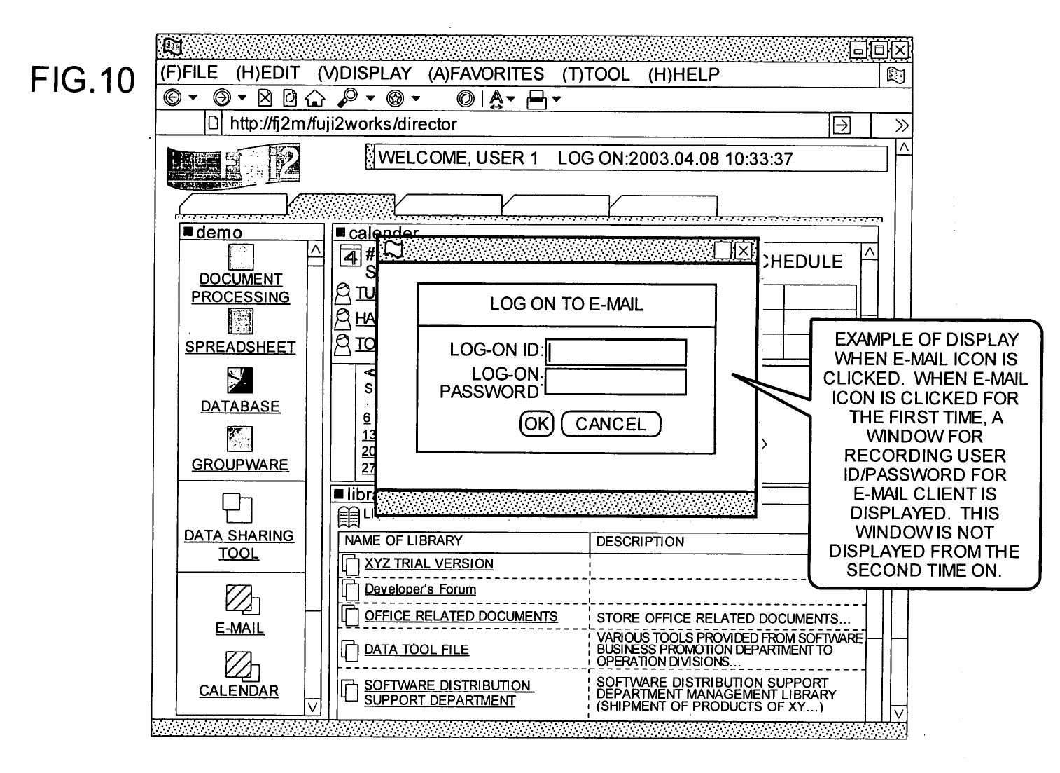

When the user starts the e-mail client (8), and if the user has started the e-mail client for the first time, an input form (screen) is displayed for entering a user ID and a password required to log on to the e-mail client (9). FIG. 10 is an example of the input form. The user inputs the user ID and the password in a window shown in FIG. 10 (10).

If the user starts the e-mail client a second time or thereafter, the web browser 120 receives the user ID and the password from the portal-screen management program 210 (11).

The OCX requests a script for starting the e-mail client from the portal-screen management program 210 (12), receives the script from the portal-screen management program 210 (13), and executes the script (14).

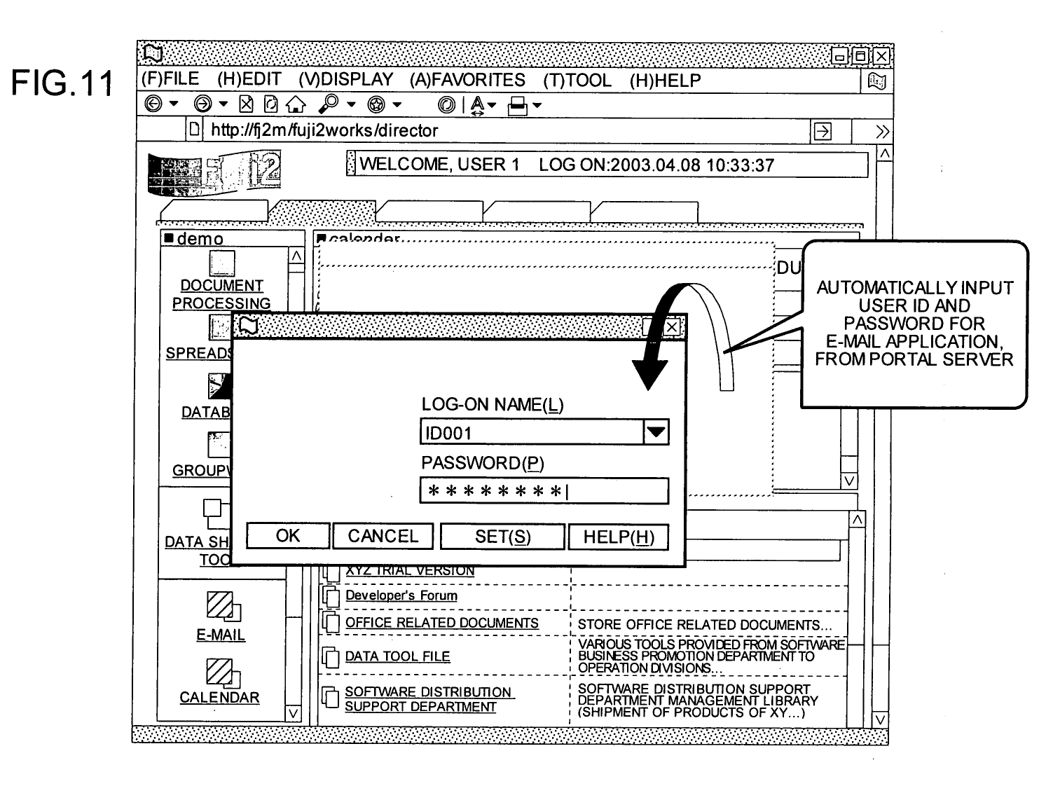

The script executed by the OCX starts the e-mail client (15), and performs a log-on sequence for the e-mail client (16). FIG. 11 is an example of a screen displayed when the log-on sequence is performed. The user ID and the password are automatically input in a window shown in FIG. 11.

The OCX waits for the e-mail client to start (17), and clicks an in-box when the e-mail client starts (18), and then the process ends (19).

When the e-mail client starts for the first time, the web browser 120 transmits the user ID and the password to the portal-screen management program 210. The portal-screen management program 210 encrypts the user ID and the password, and stores them as authentication data corresponding to the user in a repository (the portal-screen data storing unit 211) (20). If the e-mail client does not start properly, the web browser 120 does not transmit the user ID and the password to the portal-screen management program 210.

Thus, the OCX incorporated in the web browser 120 receives the script for starting the e-mail client from the portal-screen management program 210, and executes the script so that the e-mail client can be started from the portal screen.

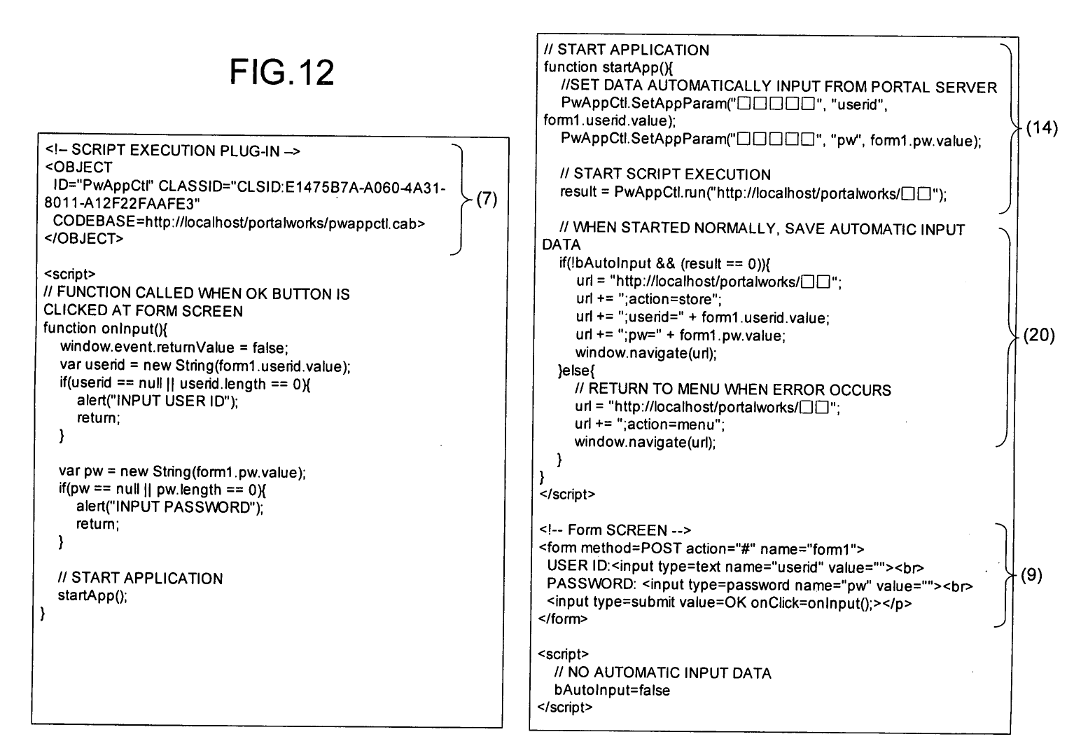

FIG. 12 is a part of an example of the portal HTML 300. A description denoted by (7) in FIG. 12 corresponds to the step (7) of downloading the OCX in the sequence shown in FIG. 9.

A description denoted by (14) in FIG. 12 corresponds to the step (14) of executing the script in the sequence shown in FIG. 9. This is the part of the script for starting the client application 110.

In (14), a user ID of the client application 110 is set to PwAppCtl.SetAppParam(“□□□□□”,“userid”,form1.userid.value);. A password of the client application 110 is set to PwAppCtl.SetAppParam(“□□□□□”,“pw”,form1.pw.value);. In these descriptions, PwAppCtl.SetAppParam corresponds to the OCX. The script for starting the client application 110 is executed by PwAppCtl.run (“http://localhost/portalworks/□□”), where PwAppCtl.run corresponds to the OCX.

A description denoted by (20) in FIG. 12 corresponds to the step (20) of saving a user ID and a password in the sequence shown in FIG. 9. A description denoted by (9) in FIG. 12 corresponds to the step (9) of displaying the input form in the sequence shown in FIG. 9.

In the descriptions, □ represents a part that varies depending on the client application. By replacing these parts, HTML descriptions for starting various client applications can be obtained.

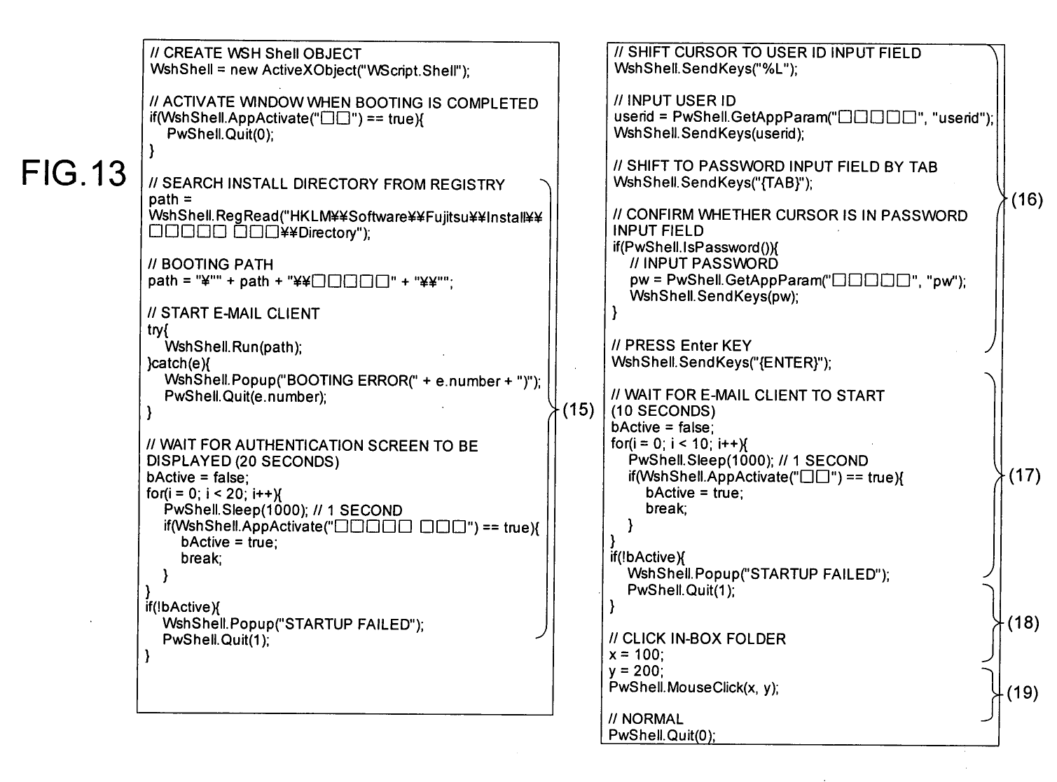

FIG. 13 is a part of an example of the script for starting the client application 110. A description denoted by (15) in FIG. 13 corresponds to the step (15) of starting the e-mail client, in the sequence shown in FIG. 9.

In (15), an install directory for the client application 110 is searched from a registry, and a path is set as path=WshShell.RegRead(“HKLM\\Software\\Fujitsu\\Install\\□□□□□ □□□\\Directory”);. A starting path of the client application 110 is set to path=“\”“+path+”\\□□□□□“+”\\“ ”. WshShell.Run(path); starts the client application 110.

A description denoted by (16) in FIG. 13 corresponds to the step (16) of performing the log-on sequence in the sequence shown in FIG. 9. A user ID is acquired by userid=PwShell.GetAppParam(“□□□□□”,“userid”); and the user ID is entered using WshShell.SendKeys(userid);. The script executing unit 312 shifts to a password entering field, WshShell.Sendkeys(“{TAB}”);, acquires a password using pw=PwShell.GetAppParam(“□□□□□”,“pw”);, and enters the password using WshShell.SendKeys(pw);.

A description denoted by (17) in FIG. 13 corresponds to the step (17) of waiting for the e-mail client to start, in the sequence shown in FIG. 9. A description denoted by (18) in FIG. 13 corresponds to the step (18) of clicking the in-box of the e-mail client in the sequence shown in FIG. 9.

A coordinate on a screen is specified by x=100; y=200 and the coordinate is clicked using PwShell.MouseClick(x,y);. A description denoted by (19) in FIG. 13 corresponds to the step (19) of ending the startup process in the sequence shown in FIG. 9.

The script is used for starting the e-mail client, performing the log-on sequence, double-clicking the in-box, and so forth. In the descriptions, □ represents a part that varies depending on the client application. By replacing these parts, scripts for starting various client applications can be obtained.

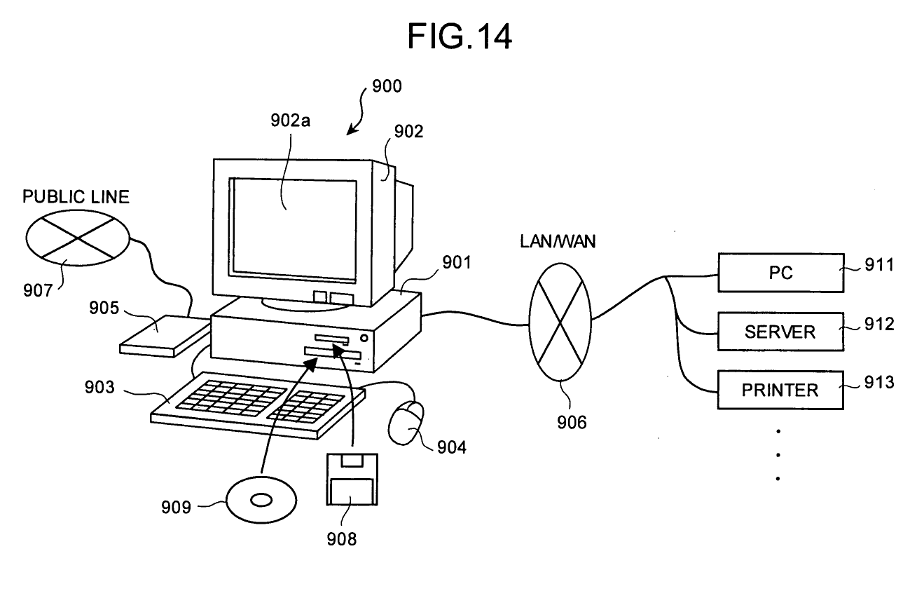

FIG. 14 is a diagram of a computer system 900 that executes the web browser 120 and the client application 110, or the portal-screen management program 210. The computer system 900 includes a main unit 901, a display 902 that displays data on a screen 902a in response to an instruction from the main unit 901, a keyboard 903 used to input data into the computer system 900, a mouse 904 that specifies a position on the screen 902a, a local area network (LAN) interface for connecting to LAN 906 or a wide area network (WAN), and a modem 905 for connecting to a public line 907 such as the Internet. The LAN 906 connects the computer system 900 to another computer system (PC) 911, a server 912, a printer 913, and so forth.

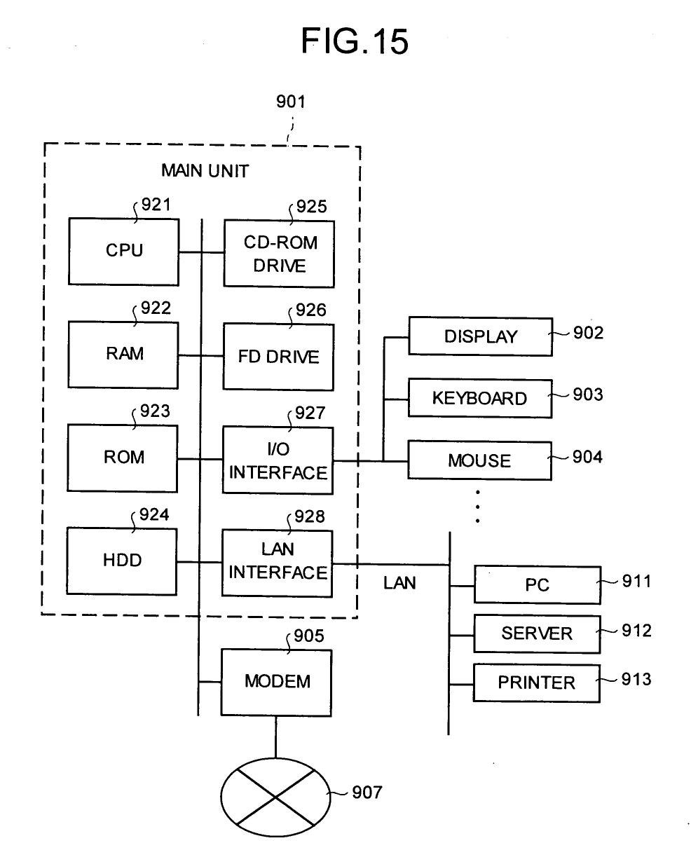

FIG. 15 is a functional block diagram of the main unit 901 shown in FIG. 14. The main unit 901 includes a CPU 921, a RAM 922, a ROM 923, a hard disk drive (HDD) 924, a CD-ROM drive 925, an FD drive 926, an I/O interface 927, and a LAN interface 928.

The web browser 120 and the client application 110, or the portal-screen management program 210 executed by the computer system 900 are stored in portable storage media such as a floppy disk (FD) 908, a CD-ROM 909, a DVD disk, a magneto-optical disk, and an IC card. The web browser 120 and the client application 110, or the portal-screen management program 210 are read from such storage media, and installed in the computer system 900.

Alternatively, the web browser 120 and the client application 110, or the portal-screen management program 210 can be stored in a database in the server 912 connected through the LAN interface 928, a database in another computer system connected through the public line 907, and so forth. The web browser 120 and the client application 110, or the portal-screen management program 210 are read from such databases, and installed in the computer system 900.

The installed web browser 120 and the client application 110, or the portal-screen management program 210 is stored in the HDD 924, and executed by the CPU 921 using the RAM 922 and the ROM 923.

According to the embodiment, when a user accesses the portal screen for the first time, the web browser 120 receives the booting OCX 310 from the portal-screen management program 210, and incorporates the booting OCX 310 as a plug-in program. When the user selects the client application 110 from the portal screen, the booting OCX 310 receives the script for starting the client application 110 from the portal-screen management program 210, and executes the script. Therefore, the client application 110 can be directly started from the portal screen. Thus, both web-related services and client application services are offered in a single, seamless environment.

According to the embodiment, the portal-screen data storing unit 211 stores a user ID and a password required to use the client application 110. Unless the client application 110 is started for the first time, the authentication-data processing unit 215 automatically inputs the user ID and the password. Thus, the user is not required to input the user ID and the password every time the client application 110 starts, thereby providing efficient use of the client application 110.

According to the embodiment, the script executed by the booting OCX 310 automatically performs the initial operations required for using the client application 110. Thus, the user can omit such operations, thereby providing efficient use of the client application 110.

According to the embodiment, the booting OCX 310 receives the script for starting the client application 110 from the portal-screen management program 210, and executes the script to start the client application 110. However, the present invention is not limited to this example. The booting OCX 310 can directly start the client application 110, or the booting OCX 310 can interpret and execute a portal HTML to directly start the client application 110.

According to the present invention, a user specifies a client application installed in a client device from a web page to start the client application. Upon receiving a request from the client device, a web data management program reads from a memory an application startup procedure for starting the specified client application, and transmits the application startup procedure to the client device. Thus, the client application installed in the client device can be started from a web browser directly, so that both web-related services and client application services are offered in a single, seamless environment.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to manage data on a web page, through a web browser at a client device via a network, wherein the computer program includes instructions which, when executed, cause the computer to execute:
receiving a request from the client device to start a client application installed in the client device, wherein the client application is specified by a user on the web page;
reading, from a memory, a startup procedure for starting the client application, when the request is received; and
transmitting the startup procedure to the client device.

2. The recording medium according to claim 1, wherein the startup procedure includes
acquiring, form the user, user-authentication data required to use the client application, and
passing the user-authentication data from the memory to the client application.

3. The recording medium according to claim 2, wherein
the acquiring is performed if the client application is started a first time, and the acquiring further includes storing the user authentication data in the memory, and
the passing is performed if the client application is started a second time or thereafter.

4. The recording medium according to claim 1, wherein the startup procedure includes executing the client application.

5. The recording medium according to claim 1, wherein the startup procedure includes
acquiring a program component stored in the memory, and
executing the program component to start the client application.

6. The recording medium according to claim 5, wherein the executing includes
acquiring a script stored in the memory, and executing the script acquired, to start the client application.

7. An apparatus for managing data on a web page, through a web browser at a client device via a network, comprising:
a receiving unit that receives a request from the client device to start a client application installed in the client device, wherein the client application is specified by a user on the web page;
a reading unit that reads, from a memory, a startup procedure for starting the client application, when the request is received; and
a transmitting unit that transmits the startup procedure to the client device.

8. A method of for managing data on a web page, through a web browser at a client device via a network, comprising:
receiving a request from the client device to start a client application installed in the client device, wherein the client application is specified by a user on the web page;
reading, from a memory, a startup procedure for starting the client application, when the request is received; and
transmitting the startup procedure to the client device.
